(19) United States
(12) Patent Application Publication
(10) Pub. No.: US 2009/0152322 A1
(43) Pub. Date: Jun. 18, 2009

(54) NAIL GUN WITH LATERAL LIFTING TYPE FRONT LID

(75) Inventor: Joe LIN, La Mirada, CA (US)

Correspondence Address: BROWDY AND NEIMARK, P.L.L.C.;624 NINTH STREET, NW, SUITE 300, WASHINGTON, DC, 20001-5303, US

(73) Assignee: Sandy Lin, La Mirada, CA (US)

(21) Appl. No.: 11/957,856

(22) Filed: Dec. 17, 2007

(51) Int. Cl. B25C 1/00

(52) U.S. Cl. 227/139

(57) ABSTRACT

A nail gun includes a gun body having a driving apparatus therein, a muzzle at an end thereof, a front plate under the muzzle, a magazine beside the front plate to store nails therein, and a grip. A pivot portion is provided on the gun body under the muzzle and beside the front plate. A front lid has a pivot base portion to pivot the pivot portion therein, and a first lock portion opposite to the pivot base portion. The first lock portion may secure the front lid on the front plate when the front lid is turned against the front plate. A second lock portion is provided on the other side of the front plate to secure the front lid for not moving and turning when the front lid is turned against the front plate.

### BACKGROUND OF THE INVENTION

1. Field of the Invention

The present invention relates generally to a nail gun, and more particularly to a nail gun having a front lid opened at lateral side that may quickly move the jammed nail away.

2. Description of the Related Art

For conventional nail guns capable of removing the jammed nail from the gun when user is using the nail gun, the nail guns are provided with a front lid in front of a front plate 2 of a nail magazine, which is under a firing pin of the gun. The front lid is capable of quick release that user may open the front lid quickly to remove the jammed nail. Typically, there are two types of the front lids: the first type is that the front lid may separate from the gun, as shown in FIG. 1. In this type of front lid, the gun is provided with a locking structure 4 for coupling the front lid to the gun and for separating. The coupling structure 4 usually is provided at a position in front of the front lid that the nail gun doesn't have a fancy look and user always loses the front lid when the front lid is separated. This type of nail gun is inconvenient in operation.

The second type is lifting type front lid, in which the front lid has a top edge pivoted on the gun so that the front lid may be lifted for open. In this type of nail gun, the front lid will not separate from the gun. However, there still is a locking structure in front of the front lid, and the gun must have a space or a recess for user to lift the front lid that the nail gun still doesn't have a fancy look. Besides, it is inconvenient that the gravity will turn the front lid down to affect the nail removal task when user lifts the front lid and removes the jammed nail.

### SUMMARY OF THE INVENTION

The primary objective of the present invention is to provide a nail gun with a lateral lifting type front lid that has a simple structure and an easy way of operation.

According to the objective of the present invention, a nail gun includes a gun body having a driving apparatus therein, a muzzle at an end thereof, a front plate under the muzzle, a magazine beside the front plate to store nails therein, and a grip. A pivot portion is provided on the gun body under the muzzle and beside the front plate. A front lid has a pivot base portion to pivot the pivot portion therein, and a first lock portion opposite to the pivot base portion. The first lock portion may secure the front lid on the front plate when the front lid is turned against the front plate. A second lock portion is provided on the other side of the front plate to secure the front lid for not moving and turning when the front lid is turned against the front plate.

### BRIEF DESCRIPTION OF THE DRAWINGS

FIG. 1 is a lateral view of the conventional nail gun;

FIG. 2 is a front view of a preferred embodiment of the present invention;

FIG. 3 is a lateral view of the preferred embodiment of the present invention;

FIG. 4 is an exploded view of the preferred embodiment of the present invention;

FIG. 5 is a sectional view along the 5-5 line of FIG. 3;

FIG. 6 is a front view of the lock plate and the gun body; and

FIG. 7 is a back view of the lock plate.

### DETAILED DESCRIPTION OF THE INVENTION

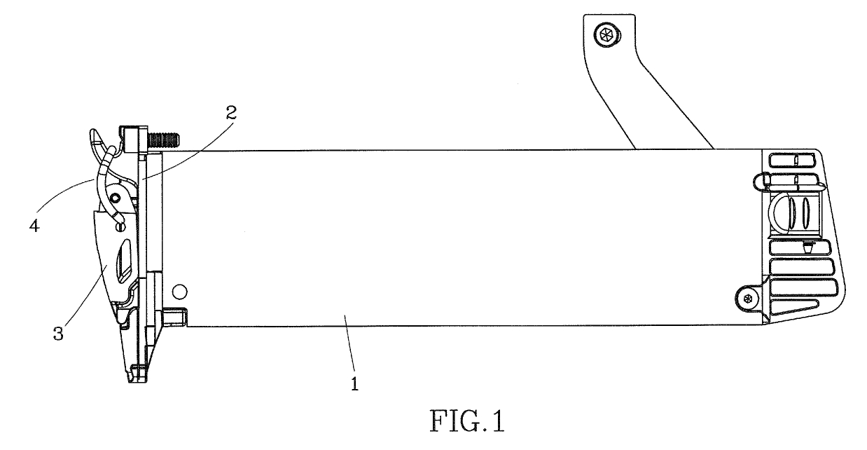

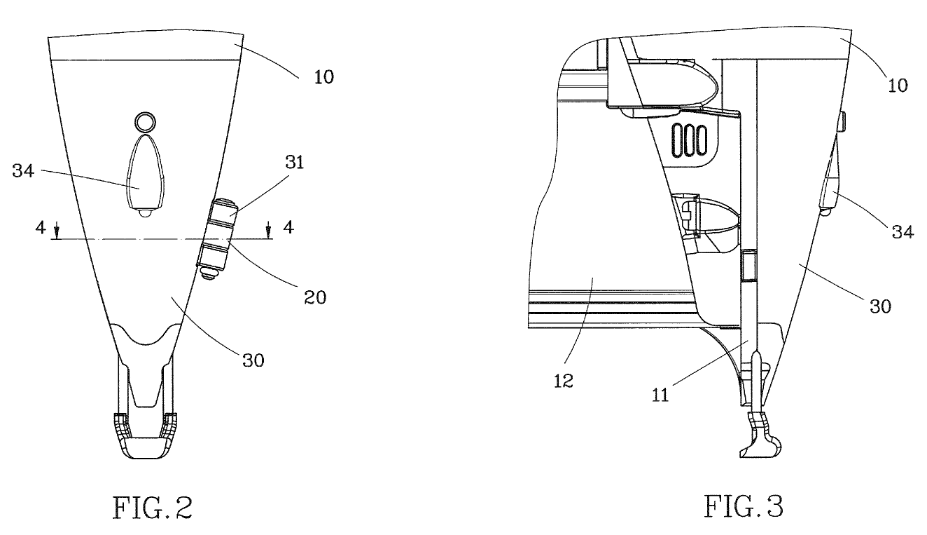

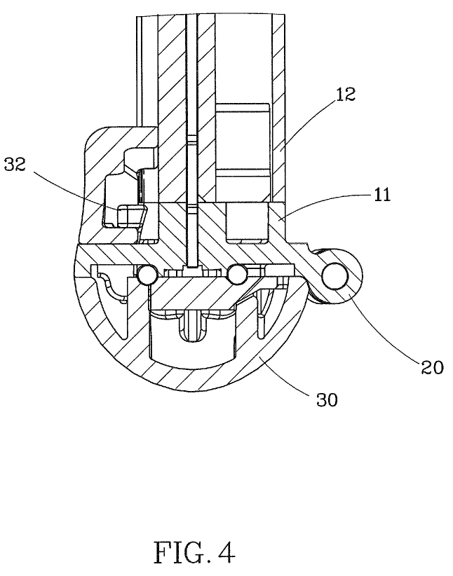

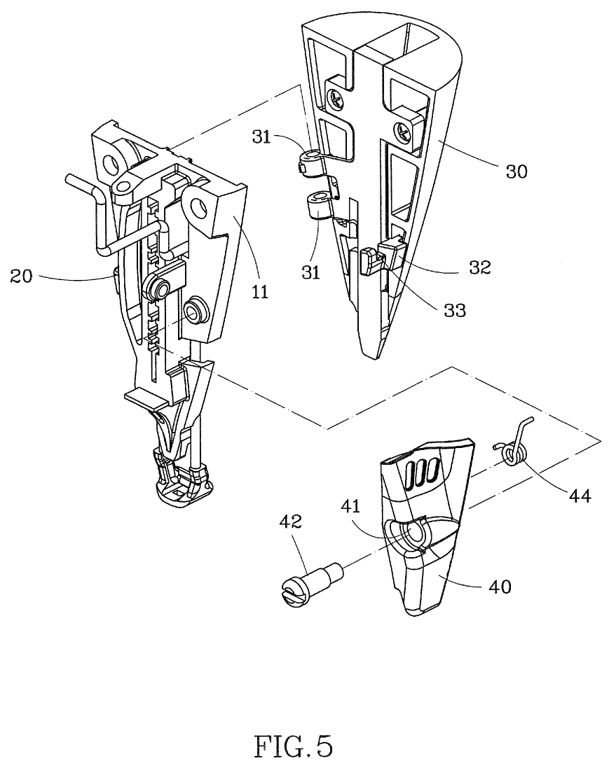

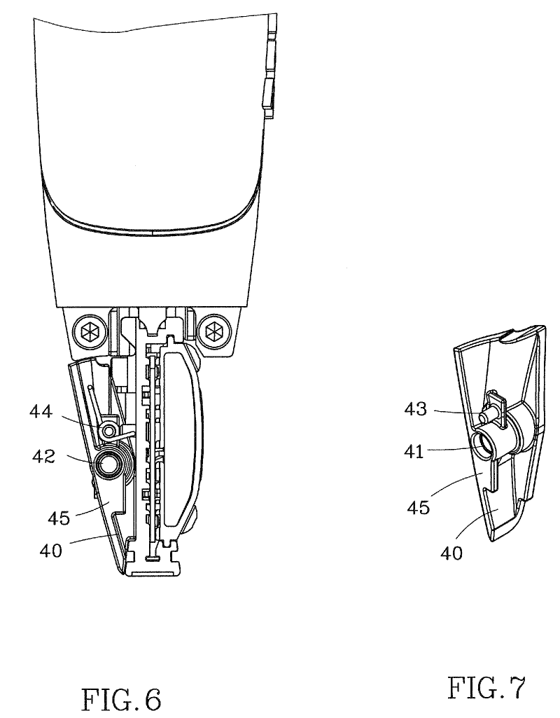

As shown in FIG. 1 to FIG. 7, a nail gun of the present invention includes:

A gun body 10, which is powered by electricity or pneumatic power, has a driving apparatus (not shown), a muzzle (not shown) at an end thereof, a firing pin (not shown) driven by the driving apparatus for reciprocation, a front plate 11 under the muzzle, a grip (not shown), and a magazine 12. The front lid 11 is a rectangular plate with two long sides and two short sides. The magazine 12 is provided beside the front plate 11 to store nails therein.

A pivot portion 20, referring to FIGS., is provided on the long side of the front plate 11 under the muzzle of the gun body.

A front lid 30 has a pivot base portion 31 to be pivoted on the pivot portion 20 of the front plate 11 of the gun body that the front lid 30 may be turned with the pivot base portion 31 as the rotation center. The front lid 30 further has a first lock portion 32 at a side opposite to the pivot base portion 31 that the front lid 30 may be locked with the front plate 11 when the front lid 30 is closed. In the present invention, the first lock portion 32 is a post with a slot 33 thereon. The front lid is provided with a light 34 for illumination.

A second lock portion 40 is provided on the other side of the front plate 11 to be engaged with the front lid 30 when the front lid 30 is closed. In the present invention, the second lock portion 40 is a plate with a bore 41 thereon and a shaft 42 in the bore 41. The shaft 41 has an end passing the back side of the front plate 11. The second lock portion 40 further has a post 43 above the bore and a spring 44 fitted to the post 43. The second lock portion 40 has the shaft 42 pivoted on the back side of the front plate 11 adjacent to the magazine 12. The second lock portion 40 has a wall 45 at the side facing the front plate 11. The wall 45 will be engaged with the slot 33 of the post of the front lid when front lid 30 is closed to fix the front lid 30 on the front plate 11. There are many alternate ways for engagement of the front lid 30 and the second lock portion 40 that still should be within the scope of the present invention.

With the structure above, the front lid 30 is closed onto the front plate 11 in a normal condition with the post of the front lid passing the front plate and into the second lock portion 40 and the wall 45 of the second lock portion engaged with the slot 33 of the post of the front lid 30. In such condition, the nail gun is operated as a conventional nail gun. When user has to open the front lid, he/she only needs to press the upper portion of the second lock portion 40 to compress the spring 44 that the second lock portion 40 may be turned along the shaft 42 to disengage the wall 45 with the slot 33. As a result, the front lid 30 is free to open, and user may remove the jammed nail. In the present invention, the front lid will not lose in operation, and the front lid will not close because of the gravity. The front side of the front lid of the present invention has no complex locking structure that the look of the nail gun of the present invention is clean, and it has enough space to mount the light for illumination that never finds in the conventional nail gun.

The description above is a few preferred embodiments of the present invention and the equivalence of the present invention is still in the scope of the claim of the present invention.

What is claimed is:

1. A nail gun, comprising:
a gun body having a driving apparatus therein, a muzzle at an end thereof, a front plate under the muzzle, a magazine beside the front plate to store nails therein, and a grip;
a pivot portion provided on the gun body under the muzzle and beside the front plate;
a front lid having a pivot base portion to pivot the pivot portion therein, and a first lock portion opposite to the pivot base portion to secure the front lid on the front plate when the front lid is turned against the front plate; and
a second lock portion on the other side of the front plate to secure the front lid for not moving and turning when the front lid is turned against the front plate.

2. The nail gun as defined in claim 1, wherein the first lock portion includes a post.

3. The nail gun as defined in claim 2, wherein the post has a slot.

4. The nail gun as defined in claim 3, wherein the second lock portion includes a plate, on which a wall is provided at a side thereof facing the front plate to be engaged with the slot of the post when front lid is turned against the front plate.

5. The nail gun as defined in claim 4, wherein the second lock portion has a bore, in which a shaft is inserted, and the shaft passes to a back side of the front plate to pivot the plate of the second lock portion on the back side of the front plate beside the magazine.

6. The nail gun as defined in claim 5, wherein the second lock portion further has a post above the bore, and a spring fitted to the post.

7. The nail gun as defined in claim 1, further comprising a light mounted on the front lid for illumination.

8. The nail gun as defined in claim 1, wherein the front plate is a rectangular plate with two long sides and two short sides.

9. The nail gun as defined in claim 8, wherein the pivot portion is provided on the long side of the front plate under the muzzle of the gun body.
